(19) United States
(12) Patent Application Publication
(10) Pub. No.: US 2015/0106883 A1
(43) Pub. Date: Apr. 16, 2015

(54) SYSTEM AND METHOD FOR RESEARCHING AND ACCESSING DOCUMENTS ONLINE

(71) Applicants: Fharo Miller, Palos Verdes, CA (US); Yoko Maeda, Palos Verdes, CA (US)

(72) Inventors: Fharo Miller, Palos Verdes, CA (US); Yoko Maeda, Palos Verdes, CA (US)

(21) Appl. No.: 14/511,050

(22) Filed: Oct. 9, 2014

Related U.S. Application Data
(60) Provisional application No. 61/889,037, filed on Oct. 10, 2013.

(51) Int. Cl. G06F 17/30; H04L 29/06

(52) U.S. Cl. CPC G06F 17/30011; H04L 63/10; H04L 63/08
USPC 726/4; 707/770

(57) ABSTRACT

Implementations of the present disclosure disclose a system and method for researching and accessing document online comprising, an online system allowing a consumer to search for documents in various online locations, a method of allowing a consumer to purchase and retrieve those documents from the various location through one system, and a method and system of granting the consumer instant access to the documents.

### CROSS-REFERENCE TO RELATED APPLICATION

This application claims the benefit of U.S. Provisional Application No. 61/889,037, filed Oct. 10, 2013.

### TECHNICAL FIELD

At least one embodiment of the present invention relates generally to a computer based document searching, retrieval, and payment system, and more particularly to a method and corresponding system for researching, accessing, and retrieving documents online.

### BACKGROUND

Today, there are billions and billions of digital documents, including, without limitation, journals, articles, e-books, magazines, and white papers, that are available for sale to consumers through various online distribution channels. Consumers can include, without limitation, individuals, professional researchers, libraries, institutions, hospitals, companies, medical professionals, lawyers, social workers, and architects. For consumers, often times, finding the right article could be an arduous task especially considering the fact that all relevant articles are not housed and or stored in one online location nor accessible from one online location.

In fact, the right article or articles that a consumer is looking for could be stored in numerous and separate online locations that could be owned and operated by various publishers. In order for a consumer to find, purchase, and gain access to the desirous article, the consumer would have to locate the online location where the article is being offered, create an account at that online location, fund the account, purchase the article, and wait to receive the article via email or some other online delivery method. This five step process will have to be completed for each and every article that the consumer wishes to purchase.

This could be problematic for several reasons. First, having to complete a five step process each and every time a consumer wishes to purchase a document could be time consuming. Second, in this day and age, time is money; being required to search multiple online locations for the desired article or articles could take time away from more productive tasks. Third, the document could reside at a publisher's location in different parts of the world where different forms of currency are accepted. If a consumer is located in Brazil, for example, and the document is available to purchase on a publisher's website in the Congo, for example, the consumer may have a difficult time consummating the purchase due to the differences in currency type. Fourth, a consumer will have to wait anywhere from 24-72 hours before it can have access to articles. This delay could cause the consumer to miss critical deadlines.

Moreover, many of the systems and methods for researching and accessing documents online on the market today do not provide the ability for the consumer to have instant access to the desired document, which thereby defeats the usefulness of an online system. Thus, a system and method for researching and accessing documents online without the drawbacks described above is desired.

### BRIEF DESCRIPTION OF THE DRAWINGS

The features and advantages of the present disclosure as well as additional features and advantages thereof will be more clearly understood hereinafter as a result of a detailed description of implementations when taken in conjunction with the following drawings in which:

FIG. 1 illustrates a simplified block diagram of the system for researching and accessing documents online in accordance with an implementation of the present disclosure.

FIG. 2 illustrates a block diagram of the system for researching and accessing documents online in accordance with an example implementation.

FIG. 3 illustrates a sequence diagram for implementing the system for researching and accessing documents online according to an example implementation.

FIG. 4 illustrates a simplified flow chart of the processing steps of a method for researching and accessing documents online in accordance with an example implementation.

### DETAILED DESCRIPTION OF THE INVENTION

The following discussion is directed to various examples. Although one or more of these examples may be discussed in detail, the implementations disclosed should not be interpreted, or otherwise used, as limiting the scope of the disclosure, including the claims. In addition, one skilled in the art will understand that the following description has broad application, and the discussion of any implementations is meant only to be an example of one implementation, and not intended to suggest that the scope of the disclosure, including the claims, is limited to that implementation. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

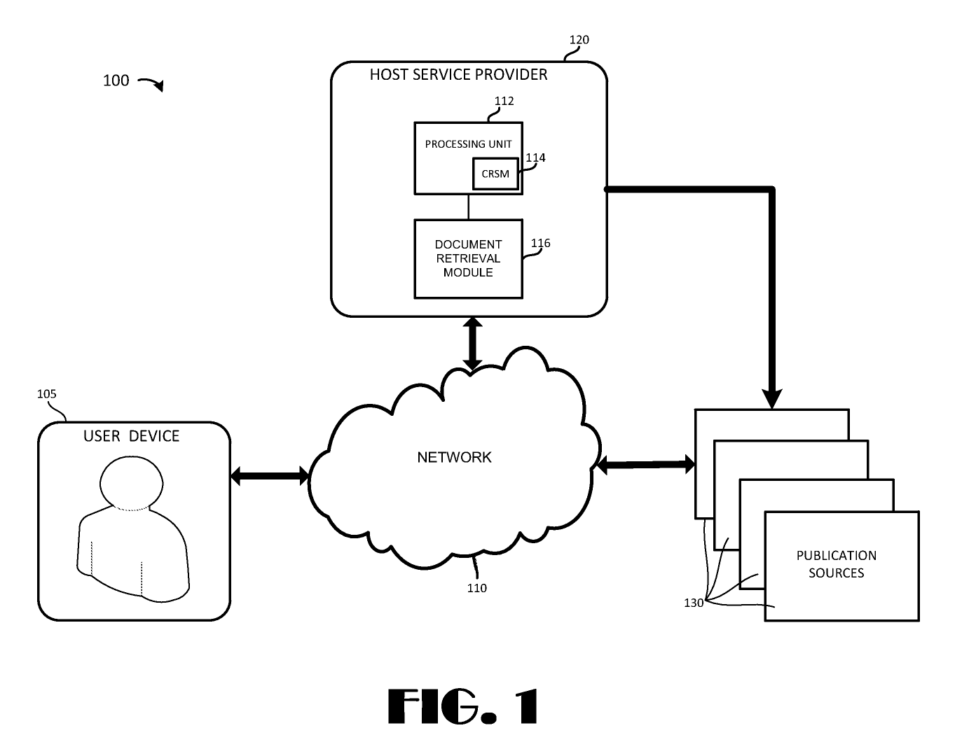

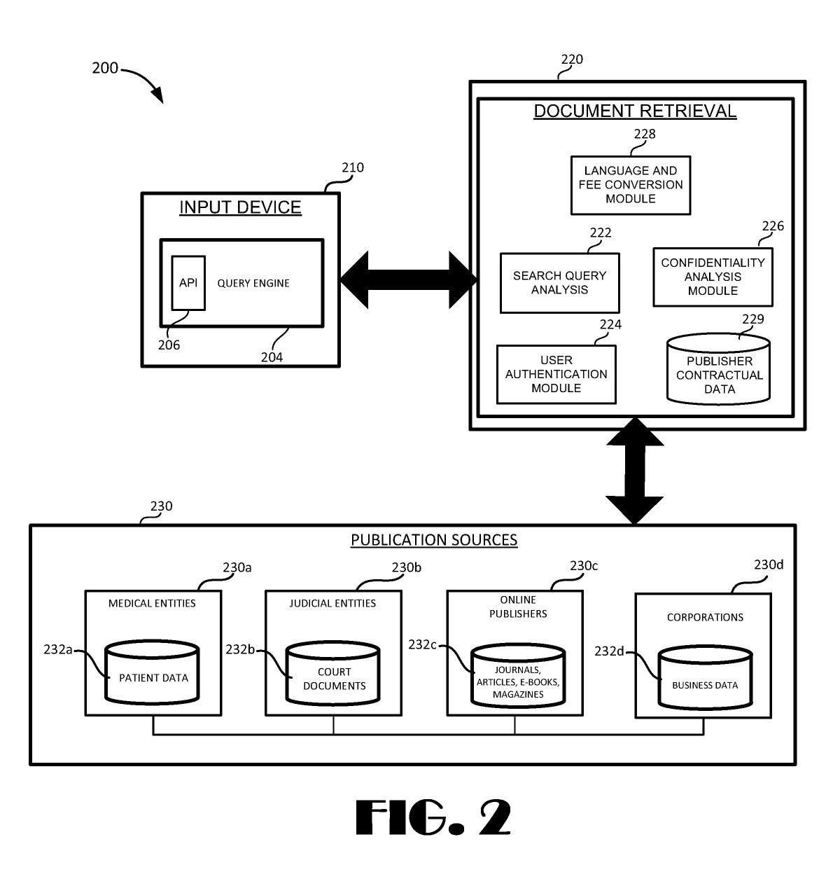

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Prior solutions provide a variety of unsuccessful techniques for implementing a system and method for researching and accessing documents online. Most prior solutions require the consumer to create an account with each publisher or owner of the desired document to consummate the purchase and retrieve the document. Furthermore, many of the conventional systems and methods for researching and accessing documents online do not allow a consumer to perform the following: (1) search for documents from an unlimited amount of publishers through a single online system, (2) create one account and have access to all the documents retrieved in the consumer's search from one online system, (3) from said system, use the currency of the consumer's native country to purchase the desired documents retrieved in the search, (4) get instant access to the purchased documents upon completion of the purchase.

Implementations of the present disclosure relate to an online system and method for allowing a consumer to search and find desirous documents from various publishers and online locations from a single system, create a single account within the online system thereby enabling the purchase and retrieval of that document irrespective of its location, and grant the consumer instant access to the document. At least one embodiment of the present invention relates generally to a computer based document searching, retrieval, and payment system, and more particularly to a method and corresponding system for researching, accessing, and retrieving documents online.

Referring now in more detail to the drawings in which like numerals identify corresponding parts throughout the views, FIG. 1 illustrates a simplified block diagram of the system for researching and accessing documents online in accordance with an implementation of the present disclosure. Here, the system 100 includes an end user and device 105, service provider or host server 120, and a plurality of publication sources 130.

The end user and device 105 represents a resource, computing device configured with network connectivity for communicating over the internetwork 110. In one example, the end user device 105 is utilized for requesting access to the host service provider 120. More particularly, service provider 120 represents a computing architecture having at least one computer system or host server, which may be operational with numerous other general purpose or special purpose computing system environments or configurations and may include, but is not limited to, personal computer systems, server computer systems, mainframe computer systems, laptop devices, multiprocessor systems, microprocessor-based systems, network personal computers, and distributed cloud computing environments that include any of the above systems or devices, and the like. Moreover, the host server provider system 120 may be described in the general context of computer system-executable instructions stored on a computer readable storage, such as program modules, being executed by a computer system. Also, the host server or service provider 120 communicates with the publication sources 130 and further includes a processing unit 112 and document retrieval module 1167.

Processor 112 may be, at least one central processing unit (CPU), at least one semiconductor-based microprocessor, at least one graphics processing unit (GPU), other hardware devices suitable for retrieval and execution of instructions stored in machine-readable storage medium 114, or combinations thereof. For example, the processing unit 112 may include multiple cores on a chip, include multiple cores across multiple chips, multiple cores across multiple devices, or combinations thereof. Processor 112 may fetch, decode, and execute instructions to implement the approaches of the disclosed system. As an alternative or in addition to retrieving and executing instructions, processor 112 may include at least one integrated circuit (IC), other control logic, other electronic circuits, or combinations thereof that include a number of electronic components for performing the requisite functionality.

Machine-readable storage medium 114 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 114 may be encoded with a series of executable instructions for retrieving target documents from the host server 120.

As will be described in greater detail below, the publication sources 130 may represent any entity capable of producing and transmitting a published document over the internetwork 110. Namely, the proposed system incorporates a document searching tool which allows a consumer to search for documents in various online locations, while also enabling the consumer to purchase documents directly from host service provider and receive the requested document instantly.

FIG. 2 illustrates a block diagram of the system for researching and accessing documents online in accordance with an example implementation. The system includes an input device 210, host server and document retrieval module 220, and publication sources 230.

In one implementation, the input device 205 is operated by a user and utilized to input search queries for execution by the host server 220. The search queries are entered via the search engine 204 and application programming interface (API) running on the device 210. Additionally, host server and document retrieval engine 220 includes a search query analysis module 222 configured to analyze the search terms input by the user. The user may also be authenticated as a registered user with the host service provider via the user authentication module 224 (e.g., via profile information associated with the operating user). The confidentiality analysis module 226 is configured to determine a confidentiality score of a retrieved document based on an analysis of data (e.g., metadata) associated with a target document. Still further, the language and fee conversion module 228 is utilized by the host service provider 220 to assess and compare the current language of the source document with the local language of the requesting user. In the event that the languages are different, the system 220, via the language and fee conversion module 228, translates the document to the local language of the user and also converts any fees associated with the retrieval process to the native currency of the operating user.

According to one implementation of the present disclosure, documents 232a-232d are retrieved by the host server 220 based on contractual relationships established between the publication sources 230a-230d and the host server 220. When a search request is received by the service provider 220, the available publication sources and associated contractual information are referenced using the data stored within the publisher contractual database 229.

The publication sources 230 may be medical entities 230a such as hospitals, doctor/dental offices, judicial entities 230b, online publishers 230c, and corporations 230d for example. However, implementations of the present disclosure are not limited thereto, as the publication sources may be any governmental entity such as a school or library, small business, or any other entity capable of transmitting digital documents over a network. Similarly, the digital documents for retrieval may include, without limitation, journals, articles, e-books, magazines, and white papers, or any document that is available for sale to consumers through various online distribution channels. Consumers or users of the system 220 may include, without limitation, individuals, professional researchers, libraries, institutions, hospitals, companies, medical professionals, lawyers, social workers, and architects.

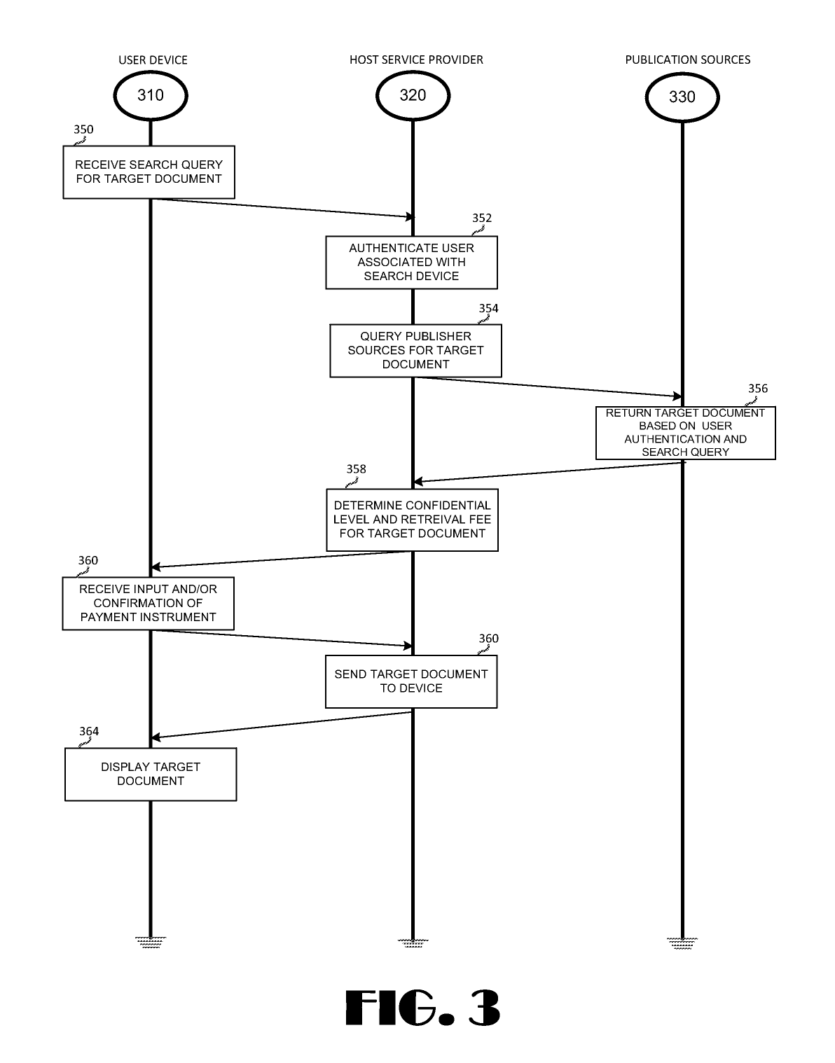

FIG. 3 illustrates a sequence diagram for implementing the system for researching and accessing documents online according to an example implementation. In segment 350, an operating user inputs a search query for a desired document within an input device. Upon receiving the request from the user in segment 352, the host service provider 320 analyzes the search string and queries the contracted publisher databases for the desired document in segment 354. The host service provider may also authenticate the user as a subscriber to the system prior to conducting the search. If the user is determined not to be a subscriber, the system may prompt the user to register for the service or include a message that the search can be conducted for a flat or variable retrieval fee (e.g., based on the type of document).

Furthermore, at least one of the plurality of publication sources returns the desired document to the host service provider based on the user profile data and the search input query in segment 356. According to one implementation, and based on the metadata associated with the retrieved document, a confidentiality level and retrieval fee is assessed and assigned to the target document in segment 358. For example, a patient or court document may include metadata indicating that the document pertains to a patient or defendant from a particular hospital or courthouse respectively. In such case, the system will determine that this document should require a second layer of authentication prior to displaying to the operating user. In one example, biometric information such as a fingerprint or retinal data is collected at the display device as a secondary authentication measure. For example, the user device may include an onboard fingerprint sensor or optical device for scanning a user's eye. In segment 360, the operating user provides the payment for the retrieval fee, which may include confirming the current charges with an existing account with the service provider, or the input of a new payment instrument, in addition to any secondary authentication process if required. Once payment is received, in segment 360 the target document is sent to the display device 310 and provided for viewing to the requesting user in segment 364.

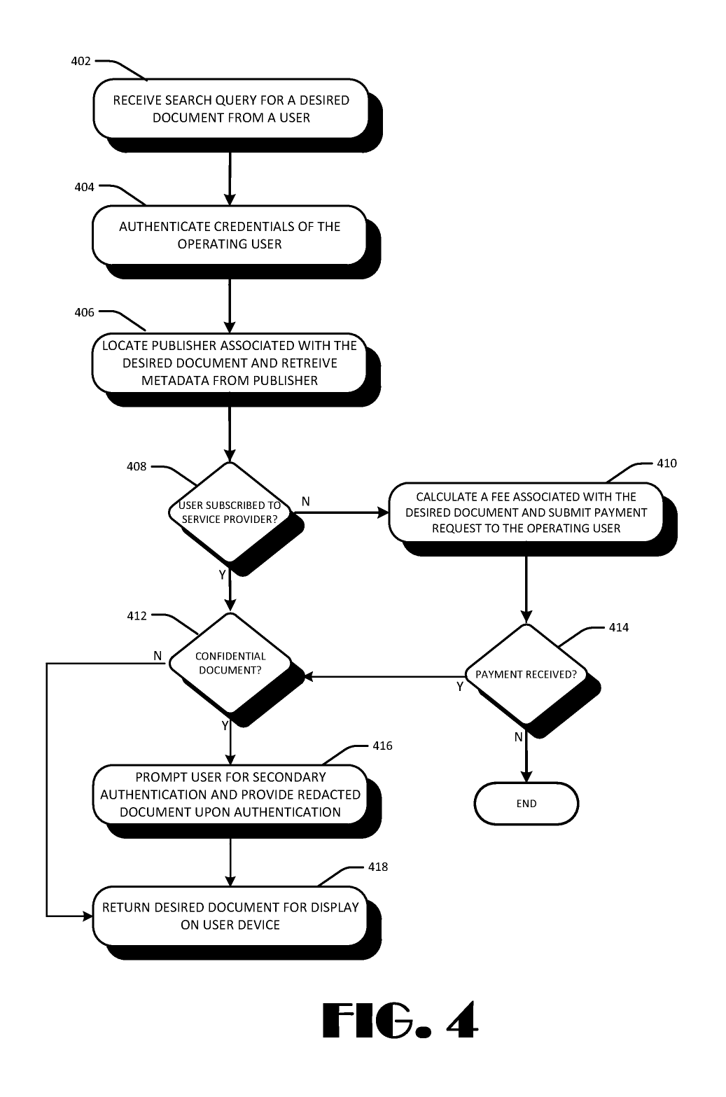

FIG. 4 illustrates a simplified flow chart of the processing steps of a method for researching and accessing documents online in accordance with an example implementation. In step 402, the search request for a desired item is received through user input of a search string via the graphical user interface and API running on the requesting device. In step 404, the credentials of the operating user may be initially authenticated (i.e., first authentication) through verification of a user ID and password combination for example. In step 406, a relevant publisher associated with target document is located and metadata extracted therefrom. Next, a determination is made as to whether the user is a subscriber to the host service provider in step 408. If not, a document retrieval fee is calculated and an associated payment request is returned to the user in step 410. If the user is verified as a subscriber in step 408, or upon receiving payment of the retrieval fee for the guest user (i.e., non-subscriber) in step 410, then the confidentiality of the document is assessed as discussed above in step 412. If the confidentiality level is considered high (i.e., document contains sensitive information) then the user is prompted to enter biometric information and a redacted form of the document is created in step 416. Conversely, if the document is not considered to be sensitive in nature, then the target document is returned to the operating user and requesting device in its entirety in step 418.

Implementations of the present disclosure provide a method and system for researching and accessing documents online. Moreover, many advantages are afforded by the implementations of the present examples. For instance, the system enables consumers to search for documents from an unlimited amount of publishers through a single online system. In addition, a registered or subscribing user can effectively create one account and have instant access to all the documents retrieved in the consumer's search from one online system. Lastly, the system and method described herein allows for translation of the target document and conversion of any fees to that of the subscriber's native country.

Furthermore, while the disclosure has been described with respect to particular examples, one skilled in the art will recognize that numerous modifications are possible. Moreover, not all components, features, structures, characteristics, etc. described and illustrated herein need be included in a particular example or implementation. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element. It is to be noted that, although some examples have been described in reference to particular implementations, other implementations are possible according to some examples. Additionally, the arrangement or order of elements or other features illustrated in the drawings or described herein need not be arranged in the particular way illustrated and described. Many other arrangements are possible according to some examples.

The techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

What is claimed is:

1. A computer-implemented method for retrieving documents over an internetwork comprising:
receiving, at the host server, a search request for a target document from a device;
determining, via the host server, the availability of the target document amongst a plurality of contracted publication sources;
retrieving, via the host server, metadata associated with the target document; and
providing for display of the target document on the user device based on the search request and said metadata.

2. The method of claim 1, further comprising:
authenticating the user associated with requesting device as a subscriber with the host service provider.

3. The method of claim 2, wherein if the user is not authenticated as a subscriber with host service provider, calculating a retrieval fee associated with the target document based on the metadata and the publication source.

4. The method of claim 1, further comprising:
determining a confidentiality level of the document based on the metadata associated with the target document.

5. The method of claim 4, wherein if the confidentiality level is higher than a predetermined threshold:
providing a secondary user authentication step on the device;
displaying a redacted version of the target document on the user device.

6. The method of claim 5, wherein the secondary authentication step includes collecting biometric information from the user via the operating device.

7. The method of claim 4, wherein if the confidentiality level is lower than a predetermined threshold, providing viewing access of the entire target document on the device.

8. The method of claim 1, wherein the target document relates to patient information from a medical institution.

9. A system for online document retrieval:
a device operated by a user;
a host service provider having a document retrieval module and in communication with a plurality of publication sources; and
wherein the document retrieval module is configured to retrieve a target document from at least one of the plurality of publication sources based on a search request from user and metadata associated with the target document.

10. The system of claim 9, further comprising:
an authentication module configured to authenticate the user of the device as a subscriber with the host service provider.

11. The system of claim 10, wherein if the user is not authenticated as a subscriber with host service provider, calculating a retrieval fee associated with the target document based on the metadata and the publication source.

12. The system of claim 9, further comprising:
a confidentiality analysis module configured to determine a confidential level based on the metadata associated with the target document.

13. The system of claim 9, wherein if the confidentiality level is higher than a predetermined threshold, then a secondary user authentication step is provided on the device and a redacted version of the target document is displayed on the user device.

14. The system of claim 13, wherein the secondary authentication step includes collecting biometric information from the user via the operating device.

15. The system of claim 9, wherein if the confidentiality level is lower than a predetermined threshold, viewing access of the entire target document is provided on the device.

16. A non-transitory computer readable medium for online document retrieval having programmed instructions stored thereon for causing a processor to:
receive a search request for a target document from a device;
determine the availability of the target document amongst a plurality of contracted publication sources;
retrieve metadata associated with the target document; and
provide for display of the target document on the user device based on the search request and said metadata.

17. The non-transitory computer readable medium of claim 13, wherein the programmed instructions stored thereon further cause the processor to:
determine a confidentiality level of the document based on the metadata associated with the target document.

18. The non-transitory computer readable medium of claim 17, wherein if the confidentiality level is higher than a predetermined threshold, the programmed instructions stored thereon further cause the processor to provide a secondary user authentication step on the device;
display a redacted version of the target document on the user device.

19. The non-transitory computer readable medium of claim 18, wherein the secondary authentication step includes collecting biometric information from the user via the operating device.

20. The non-transitory computer readable medium of claim 17, wherein if the confidentiality level is lower than a predetermined threshold, the programmed instructions stored thereon further cause the processor to:
provide viewing access of the entire target document on the device.
